(19) United States
(12) Patent Application Publication
(10) Pub. No.: US 2024/0193935 A1
(43) Pub. Date: Jun. 13, 2024

(54) AUTOMATED SELECTION AND SEMANTIC CONNECTION OF IMAGES

(71) Applicant: Siemens Mobility GmbH, Munich (DE)

(72) Inventors: Heinrich Helmut Degen, Plainsboro, NJ (US); Stefan Kluckner, Berlin (DE); Martin Kegalj, Berlin (DE)

(73) Assignee: Siemens Mobility GmbH, Munich (DE)

(21) Appl. No.: 18/553,627

(22) PCT Filed: Apr. 21, 2022
(86) PCT No.: PCT/US2022/025708

§ 371 Date: Oct. 2, 2023

Related U.S. Application Data
(60) Provisional application No. 63/177,421, filed on Apr. 21, 2021.

(51) Int. Cl. G06V 10/98; G06V 10/75; G06V 10/771; G06V 20/56

(52) U.S. Cl. CPC G06V 10/993; G06V 10/751; G06V 10/771; G06V 20/56

(57) ABSTRACT

The analysis of images is used in many industries. An example use case involving the analysis of images across several industries relates to the maintenance of immobile and mobile systems, such as, by way of example, trains, busses, building equipment, manufacturing devices, gas turbines, power lines, medical devices, and manufacturing outcomes. Current image analysis systems often involve artificial intelligence (AI) based images and object recognition algorithms. Such AI-based algorithms can identify findings that may require a corrective action, but such corrective action may require a human operator to evaluate the finding. Example systems described herein can automatically select and display images suitable for the human eye. Furthermore, various user interfaces allow operators to efficiently evaluate large amounts of images and data associated with the images.

### CROSS-REFERENCE TO RELATED APPLICATIONS

This application claims the benefit of U.S. Provisional Application Ser. No. 63/177,421 filed on Apr. 21, 2021, the disclosure of which is incorporated herein by reference in its entirety.

### BACKGROUND

The analysis of images is used in many industries. An example use case involving the analysis of images across several industries relates to the maintenance of immobile and mobile systems, such as, by way of example, trains, busses, building equipment, manufacturing devices, gas turbines, power lines, medical devices, and manufacturing outcomes. Current image analysis systems often involve artificial intelligence (AI) based images and object recognition algorithms. Such AI-based algorithms can identify findings that may require a corrective or preventative action. For example, findings can define anomalies that identify existing damage or future damage. By way of example, when an example application scenario relates to maintenance, a corrective action might include the repair or replacement of a component. In many cases, an operator reviews the images and the AI-based finding and so as to respond, for instance make a final decision. The final decision may include initiating a corrective action, determining which kind of corrective action(s) to take, or the like. For example, an operator's response to a given image and AI-based finding may include identifying the finding as a false positive, meaning that the AI incorrectly identified the finding as an anomaly. It is recognized herein that AI-based findings often result in inefficiencies and can result in false positives, among other technical shortcomings, which can prevent the operator from completing time-sensitive analysis of AI-based images in a timely manner.

### BRIEF SUMMARY

Embodiments of the invention address and overcome one or more of the described-herein shortcomings or technical problems by providing methods, systems, and apparatuses for automatically selecting and displaying images suitable for the human eye. In an example aspect, a computing system is configured to perform various operations related to ranking and displaying images. In some cases, the computing system can rank images, select images based various rankings, and display various selected images.

In an example aspect, cameras can capture a plurality of images of a system, for instance a train. The plurality of images can define different components of the system captured from a plurality of points of view. Based on the plurality of images, the computing system can detect a plurality of findings associated with at least one of the components. Furthermore, the system can determine a first component associated with a first finding of the plurality of findings, and identify a set of images of the plurality of images, wherein each image in the set of images includes the first finding. In various examples, the system determines quality metrics associated with each of the images in the set of images. The system can make a comparison of the quality metric to a quality threshold associated with the first component. Based on the comparison, the system can select a subset of images for display to an operator associated with the system, wherein each image in the subset of images defines the first finding, and the respective quality metric of each image in the subset meets or exceeds the quality threshold.

### BRIEF DESCRIPTION OF THE SEVERAL VIEWS OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shows an example system that includes a train having multiple train cars and cameras or sensors in communication with a central or operator computer system, in accordance with an example embodiment.

FIG. 2 illustrates an example user interface that can be displayed in accordance with an example embodiment.

FIG. 3 illustrates another example user interface that that can be displayed in accordance with another example embodiment.

FIG. 4 is a flow diagram that depicts various operations that can be performed, so as to render the user interfaces of FIGS. 2 and 3, in accordance with various example embodiments.

FIG. 5 illustrates a computing environment within which embodiments of the disclosure may be implemented.

### DETAILED DESCRIPTION

As an initial matter, it is recognized herein that in various application contexts, there can be many, for instance hundreds or thousands or more, of captured images that are “good enough” for an AI-based algorithm but not “good enough” for a human operator. As a practical matter, such a situation can require that the operator manually sort through many captured images lacking utility for the operator so as find a single image or a subset of the captured images that render sufficient information for the operator. In some cases, there is sufficient information in a given image when the operator can make a decision based on the information rendered in the image, for instance a decision regarding a corrective action. It is further recognized herein that finding the correct image, in particular an image that includes sufficient information for an operator to make a decision or take action, is often time sensitive. Thus, it can be a technical challenge to sort through images to find one or more rendering useful or sufficient information for a human operator, particularly when the operator has limited time, for instance when the operator needs to identify a corrective action, among other scenarios. Current approaches involve manual browsing by the operators that often does not comply with time constraints for performing maintenance tasks, among others.

An example application scenario described herein of various embodiments described herein involves the maintenance of a fleet of high-speed trains. It will be understood that this use case is presented by way of example, such that embodiments described herein can be applied to images concerning alternative or additional maintenance or operations implementations related to various systems (e.g., busses, building equipment, manufacturing devices, gas turbines, power lines, medical devices, traffic infrastructure, solar panels, wind turbines, underwater turbines, and manufacturing outcomes), and all such alternative implementations are contemplated as being within the scope of this disclosure.

Returning to the example use case involving the maintenance of trains, an operator, who can be referred to as a craft person, can be tasked to review findings in captured images. The craft person can be further tasked to determine or identify corrective actions for each finding. As used herein, a finding can refer to an anomaly, or to a portion of a given image that is different than what is expected or normal. As used herein, unless otherwise specified, finding an anomaly can be used interchangeably, without limitation. Continuing with the example, in some cases, the craft person in a high-speed maintenance facility has limited time, for instance 4 to 8 minutes, to perform this task (e.g., reviewing findings and identifying corrective actions) for a single coach (train car). Furthermore, in many cases, 10 to 20 findings are often expected for each coach, and in some cases, more than 20. Consequently, by way of example, a craft person can expect around 12 to 48 seconds to evaluate each finding, and in some cases, less time. By way of further example, in some cases, a given finding can have 50 to 500 images that are associated with the finding, for instance display the finding in some way. Thus, it is recognized herein that there is often not enough time (e.g., 12 to 48 seconds) for an operator to sort through that many images to find appropriate images from which they can make decision. To address this issue, among others, embodiments described herein can sort through and select (e.g., display to an operator) an image or a subset of images related to a finding that define useful and sufficient information for an operator, such that the operator can identify a corrective action.

As described above, while embodiments are described herein in the context of maintaining a high-speed train for purposes of example, embodiments can be implemented in various scenarios in which a human operator makes a decision concerning a corrective action, based on images, particularly when many images from different viewpoints and perspectives are captured and available to the operator.

Embodiments described herein address technical problems associated with identifying images, out of a set of images, which belong to the same finding. Furthermore, embodiments address how to select images that define a quality that is sufficient for human operators. In some examples, images are grouped in direction groups, such that an operator can select an image with a particular viewpoint (e.g., from the left hand side, from the right hand side, from top, from bottom, etc.). Additionally, in some cases, images can be ranked based on human-readable quality, such that the operator can access the best image with respect to different viewpoints in a single interaction step.

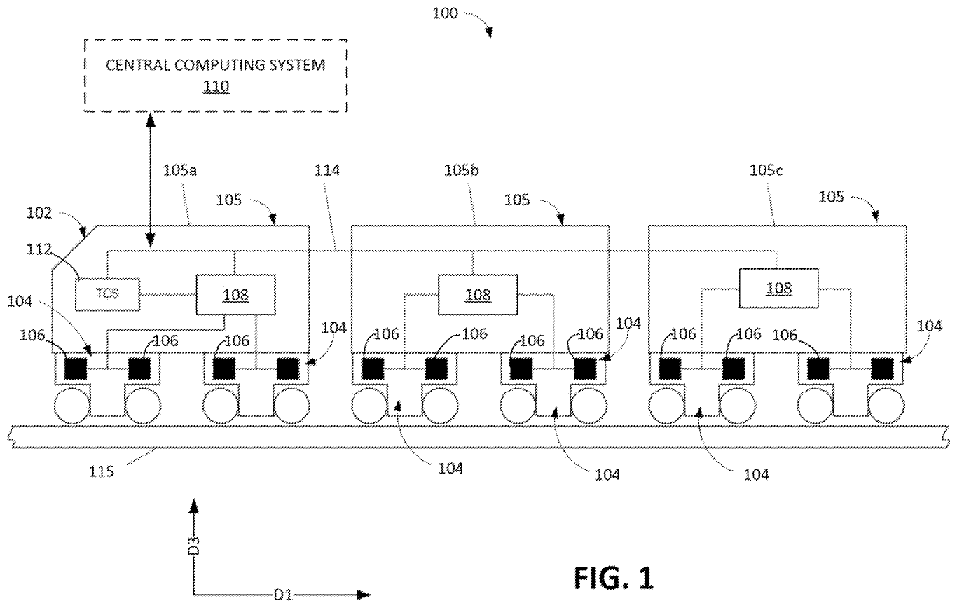

Referring now to FIG. 1, an example system 100 can capture, select, and display images related to operations of a railway vehicle or train 102. As used herein, railway vehicle or train can be used interchangeably without limitation. The system 100 can include the train 102 that includes one or more train cars or wagons 105, for instance a first train car 105a, a second train car 105b, and a third train car 105c, configured to run on a track 115. By way of example, the first train car 105a can define the front of the train 102, and the third train car 105c can define the rear of the train 102. It will be understood that the illustrated system 100 including the train 102 are simplified for purposes of example. Thus, the system 100 and the train 102 may vary as desired, and all such systems and trains are contemplated as being within the scope of this disclosure.

Still referring to FIG. 1, each train car 105 can include bogies 104, for instance a first or front bogie 104a and a second or rear bogie 104b opposite the first bogie 104a. Each bogie 104, and thus each wagon, can include one or more sensors or cameras 106 configured to capture images associated with the train 102. The cameras 106 can capture images from various perspectives or various components. For example, and without limitation, images can be captured of the bogies 104, the under carriage, motors, outer surfaces of the wagons 105, and the like. In some cases, images can be captured periodically, for instance 20 images per second, though it will be understood that the capture rate can vary as desired. It will further be understood that that the number of sensors 106 on a given wagon 105 may vary as desired. By way of example, in some cases, a given bogie 104 may include two or more sensors 106, for instance 20 or 30 sensors or more than 30 sensors 104. Example bogie components for which images can be captured by the cameras 104 include, without limitation, springs of the bogies 104, wheels of the bogies 104, dampers, busing elements of the bogies 14, and bodies of the bogies 104. The cameras 104 can capture images of various components in various directions, for instance a first or longitudinal direction D1 along which the train 102 travels, a second or lateral direction D2 that is substantially perpendicular to the first direction D1, a third or transverse direction D3 that is substantially perpendicular to both the first and second directions D1 and D2, respectively, and any direction that is angularly offset as compared to the first, second, or third directions D1, D2, and D3 respectively.

One or more of the train cars 105, for instance each train car, can define a train car computer system 108 configured to collect images from the sensor networks. In some cases, each train car computer system 108 can be communicatively coupled to a central computing system 110 that be located on the train 102 or separate from the train 102, such as within a local area network (LAN) that is communicatively coupled to the train 102. A train control system (TCS) 112 can also be located on the train 102, for instance within the first train car 105a. In some examples, the central computing system 110 defines the train control system 112. Alternatively, the central computing system 110 can be separately located from, and communicatively computed to, the TCS 112. The train control system 112 can perform various functions related to controlling the train operation. With respect to anomaly detection, the train control system 112 can receive anomaly detection messages from the bogie computer systems 108 and/or the central computing system 110.

In some examples, the central computing system 110 can be configured to receive data from multiple bogie computer systems from multiple trains. Thus, a railway computing system can include a plurality of train car computer systems 108, the central computing system 110, and one or more traffic control systems 112. Based on the collected images, the central computing system 110 and/or a given bogie computer system 108 can detect anomalies on the track or train. In some cases, each train defines a computer that receives raw data and extracts features from the raw data. The features and raw data can be from a short time period, so as to define snapshots of data. In some cases, the snapshots can be sent to the central computing system 110, which can be located on land, for further processing and/or analysis by operators.

With continuing reference to FIG. 1, the train car computer systems 108 and the train control system 112 can be connected via communications network 114. The communication network 114 may utilize conventional transmission technologies including, for example, Ethernet and Wi-Fi to facilitate communications between the train cars 105. Each train car computer system 108 may implement one or more transport layer protocols such as TCP and/or UDP. In some embodiments, the train car computer system 108 includes functionality that allows the transport protocol to be selected based on real-time requirements or a guaranteed quality of service. For example, for near-real time communications UDP may be used by default, while TCP might be used for communications that have more lax timing requirements but require additional reliability.

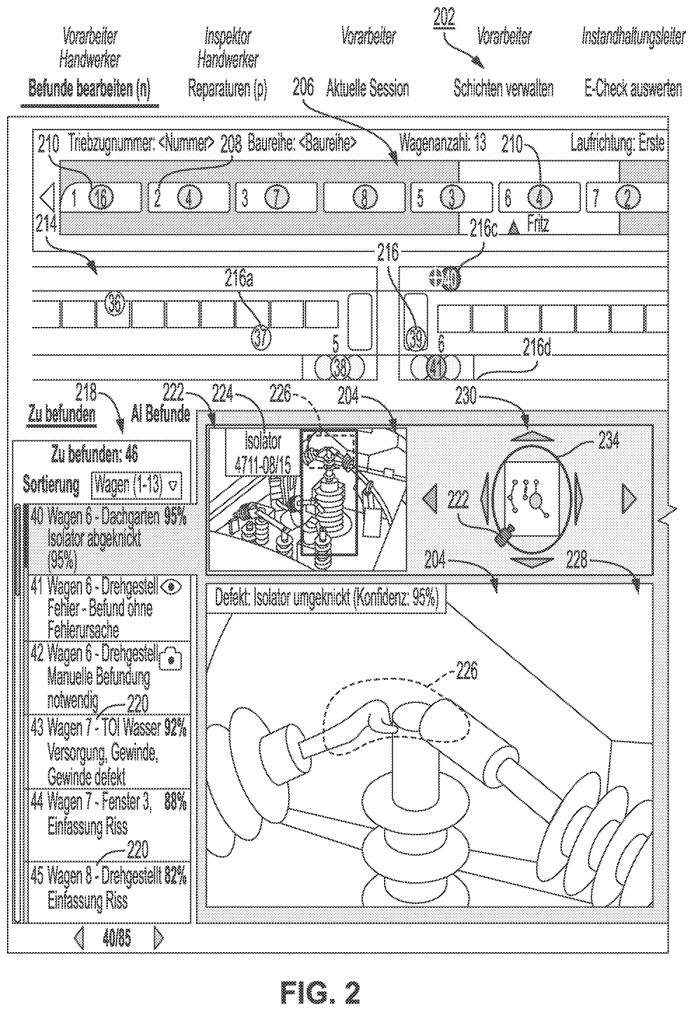

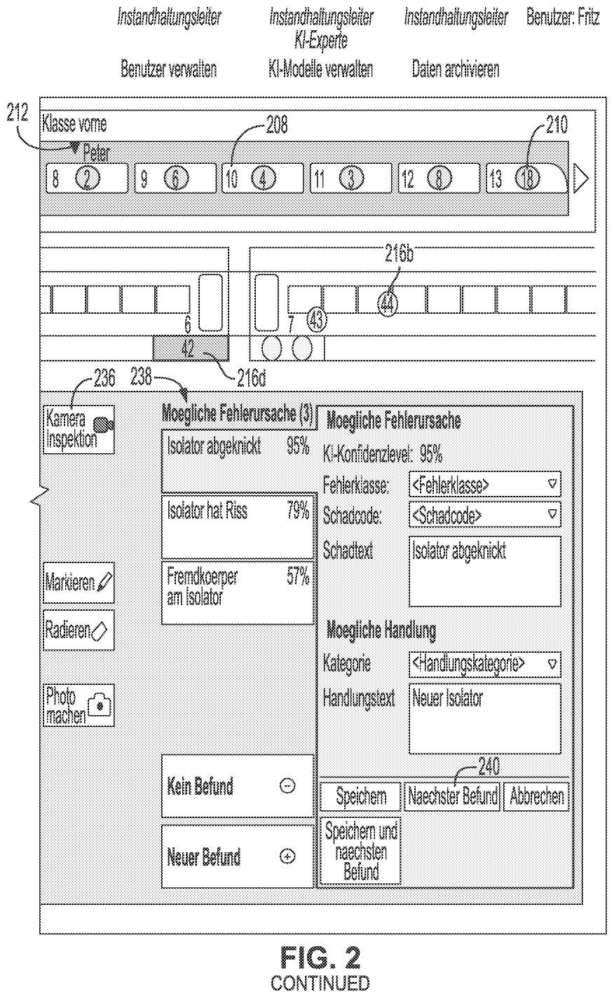

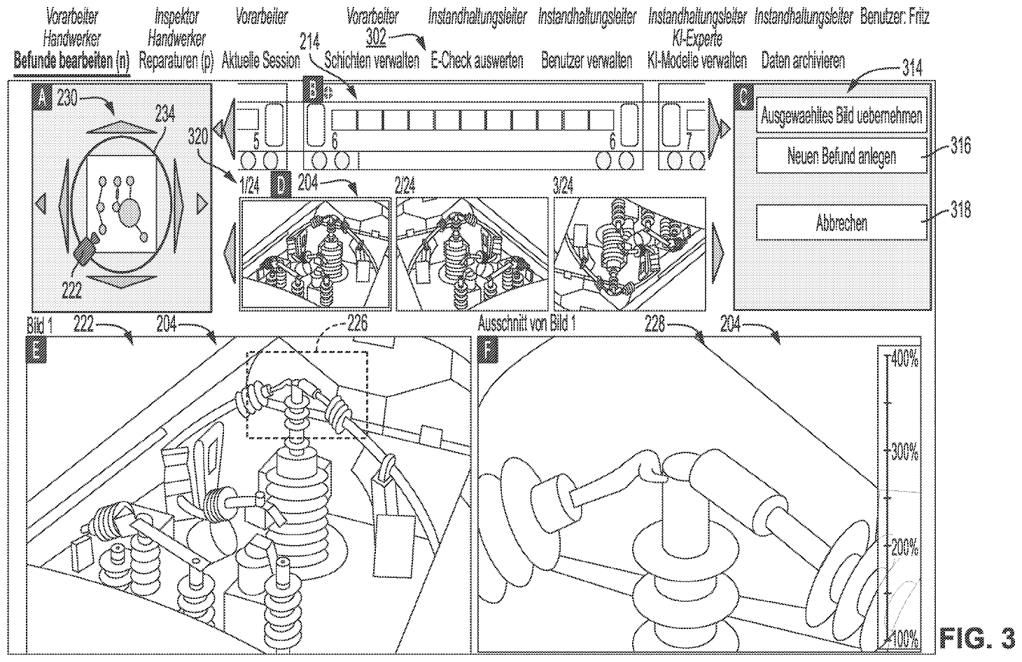

Referring now to FIGS. 2 and 3, the central computing system 110, the bogie computer system 108, or any combination thereof can define an example operator computer system 200, in accordance with various embodiments. The operator computer system 200 can include various interfaces for receiving data from external systems. The operator computer system 200 can display various interfaces to a user or operator, for instance a first interface (see FIG. 2) or a second interface 302 (see FIG. 2). It will be understood that the interfaces 202 and 302 are presented as examples, and the data on the interfaces can be alternatively arranged as desired, and all such alternative arrangements are contemplated as being within the scope of this disclosure. The operator computer system 200 can include a train car interface configured to communicate with train car sensor networks. In some examples, one or more networks can be connected to the operator computer system 200. The operator computer system 200 can include a network interface configured to connect to other networks and other computing systems, for instance the train control system 112. The network interface can implement the protocol(s) and perform any other tasks necessary to send and receive data via various networks. The operator computer system 200 can further include one or more processors and a memory storing a plurality of software programs executable by the processors. The memory may be implemented using any non-transitory computer readable medium known in the art.

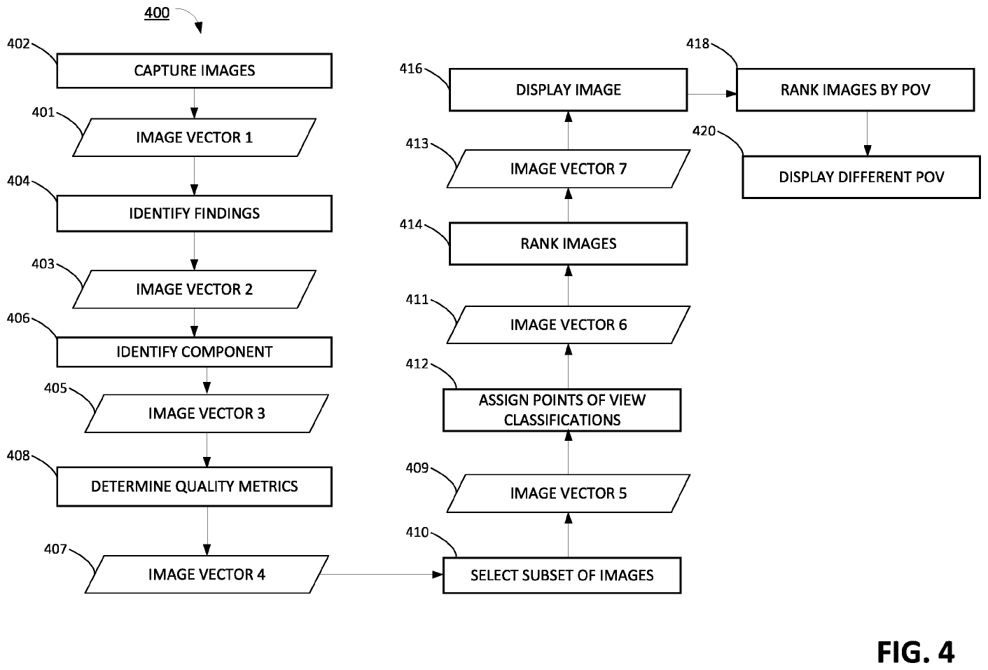

Referring now to FIG. 4, example operations 400 can be performed by the system 100, in particular the operator computer system 200, so as to select and display various information, such as the information, in particular images, displayed in user interfaces 202 and 302. At 402, the sensors 106 can take or capture an image. In some cases, the operator computer system 200 can receive the image and parameters associated with the image, for instance an ID of the camera 118 that captured the image. Based on the received image, the computer system 200 can generate image vectors, for instance a first image vector 401. The first image vector 401 can include various parameters associated with the image, for example and without limitation, an image ID, time stamp, camera ID, wagon ID, 6D pose of image, and the like. At 404, based on the first image vector 401, the system 200 can identify findings or anomalies (defects) in the image so as to generate a second image vector 403. The second image vector 403 can include various parameters associated with the image, for example and without limitation, the first image vector 401, an ID associated each of one or more findings, a location associated with the respective finding, finding size, finding type, finding description, and a proposed action associated with the respective finding.

With continuing reference to FIG. 4, at 406, based on the second image vector 403, the system 200 can identify an object or component associated with each finding of the second image vector 403, so as to generate a third image vector 405. The third image vector 405 can include various parameters associated with the image, for example and without limitation, the second image vector 403, an ID associated with each of one or more objects defined by the respective finding, a location associated with the respective object, object size, and the like. At 408, the system 200 can determine a quality metric associated with the image and/or defect (finding) within the image, based on the third image vector 405, as generate a fourth image vector 407. The quality can be determined by various parameters associated with images or findings, for example and without limitation, sharpness, contrast, brightness, object access, object display/range, and surface perspective. In some cases, the sharpness is assigned a value within a range defined by the degree to which the sharpness is recognizable by the human eye. Similarly, the contrast can be assigned a value within a range defined by the degree to which the contrast is high enough to be recognizable by the human eye, and the brightness can be assigned a value within a range defined by the degree to which the brightness is high enough to be recognizable by the human eye. The object access can be assigned a value within a range defined by whether the degree to which the object or finding defined by the object is covered, such that the object or finding is blocked from view by the human eye in the image. The object display/range can be assigned a value within a range defined by whether the degree to which the number of pixels in the image represent the image or finding. The surface perspective can be assigned a value within a range defined by whether the degree to which the surface of interest is exposed to the camera.

In some cases, the quality parameters described above can be weighted so as to compute the fourth image vector that defines the overall image quality. For example, quality parameters can be weighted based on the object in the image or based on the time in which the image was captured. By way of example, brightness might be weighted higher for an object that is located in dark space (e.g., a bogey). By way of further example, object access might be weighted higher during times when a particular object or finding might be covered by snow or debris. Additionally, or alternatively, the system 200 can perform a rule-based calculation for the image quality by performing a machine-learning based algorithm that can be used to determine the image quality per image. In some examples, each single weighted image quality parameter (e.g., for defects and for objects) can have a minimum that can be used to select an image for the fourth image vector 407. Thus, as described above, fourth image vector 407 can include various parameters associated with the image, for example and without limitation, the third image vector 405, an ID associated each image per object ID, a quality value of each image, and a quality value of each finding or anomaly (defect).

Still referring to FIG. 4, at 410, the system 200 can reduce an image set according to the image quality indicated in the fourth image vector 407, so as to generate a fifth image vector 410. For example, the system 200 can compare the fourth image vector 407 to a predetermined quality threshold. Based on the comparison, the system 200 can select images that meet or exceed the defined or predetermined quality threshold. Such a comparison can be performed for each point of view (perspective) of the associated object or finding, or each point of view classification, such that images having sufficient quality can be selected for each point of view or each point of view classification. Example classifications include, without limitation, along the first direction D1, along the second direction D2, along the third direction D3, or from a direction that is angularly offset with respect to the first, second, or third directions. Thus, the fifth image vector 409 can define a subset of the fourth image vector 407, such that images in the fifth image vector 409 meet or exceed the predetermined quality threshold.

At 412, the system 200 can assign images to point of view classifications, based on the fifth image vector 409. For example, based on the fifth image vector 409, respective object ID, and viewpoint, the system 200 can generate a sixth image vector 411 that groups images based on their respective point of views. The point of view groups can be defined by the position of the camera 106 relative to the object in the image. Thus, the sixth image vector 411 the fifth image vector 409 and a point of view assignment or classification associated with each image ID. At 414, based on the sixth image vector 411, the system 200 can rank images per point of view and per defect (finding) ID, so as generate a seventh image vector 413. For each point of view, the system 200 can perform a ranking function to rank images, for instance according to the quality parameters described above, such that the image from a given point of view having the highest quality is ranked first. Thus, the seventh image vector 413 can define the sixth image vector 411 and an assigned rank number per finding ID and per point of view. At 416, based on the seventh image vector 413, the system 200 can display an image having the highest rank, for instance an image 204 (see FIG. 2), associated with a given finding. Thus, based on the finding ID, the system 200 can display an image. Further, at 416, the system 200 can assign the highest ranked images for each point of view. In an example, the highest ranked images from each perspective (point of view) can be rendered on an image gallery 320 (see FIG. 3). An operator can interact with the image gallery 320, for instance by actuating arrow options, to scroll through and view each image that meets or exceeds, as indicated by their respective rank, a given quality threshold.

In some examples, the system 200 can calculate the ranking of the images based on different parameters and their associated quality levels. Examples of parameters, without limitation, include the contrast of an image, the brightness, the size of the object of interest in the image, etc. In some cases, the system 200 determines a quantitative value associated with each parameter (e.g., from 1 to 10 where 1 represents the lowest quality and 10 the highest quality). In an example, the total quality metric can be determined by adding up the values per parameters. In various examples, the parameters are weighted. By way of example, in dark environments, the contrast parameter might be more important than in other environments, such that the contrast parameters can receive a higher weight in those environments than other parameters, for instance color distribution or sharpness parameters. The parameters and their quality levels (e.g., from 1 to 10) can indicate the degree to which an operator, in particular a human eye, can see the object and a finding defined by the object, so that the operator can verify or evaluate the detected anomaly (finding).

In various examples, each parameter can be associated with a threshold that defines a minimum value at which the parameter meets or exceeds for the image to be considered for selection for display by the system 200. By way of example, if the contrast parameter of a given object (component) or finding or environment has a threshold of 4, images having a contrast of less than 4 (e.g., out of 10) are not considered by the system 200 for display to an operator. Similarly, in some cases, the overall quality metric determined by the system 200 can be associated with a threshold. For instance, images having an overall quality metric that is less than the threshold are rejected or not considered for display. The weights and/or thresholds can be based on context information (context-sensitive), such that they can vary based on the environment, finding, component, or the like, associated with the image. By way of example, in dark light conditions, a lower threshold for contrast and for overall images might be beneficial as compared to bright light conditions. Thus, weights of parameters can be assigned by the system 200 based on light, weather, time of day, or other contextual information associated with the image. For example, images taken on a sunny day may have different quality expectations for brightness as compared to images taken on a cloudy day. It will be understood that the preceding use cases are presented as examples of how the parameters, the quantification of the parameters, the weights, and the thresholds can vary and can be used to provide the best available images for the operator, it being understood that the parameters, the quantification of the parameters, weights, and thresholds can vary as desired in accordance with various environmental and implementation condition, and all such alternatives are contemplated as being within the scope of this disclosure. Thus, the system 200 can display the highest ranked image for a given finding (e.g., image 204), and can assign the other highest ranked images for the finding (which can be from different points of view as compared to the highest ranked image) to finding image controls in a control view 230.

With continuing reference to FIG. 2, at 418, based on a selected object ID (e.g., selected by an operator) the system 200 can rank images in their respective point of view groups according to their quality parameters. Alternatively, or additionally, based on a selected finding (defect) ID, the system 200 can rank images in their respective point of view groups according to their quality parameters. At 416, based on a selected finding or defect ID (e.g., selected by an operator), the system can display the best image having the selected finding ID. At 420, in an example, responsive to an operator selecting a different view for a finding, the system 200 can select and display a different image for the finding from a different point of view.

Referring also to FIGS. 2 and 3, the example user interfaces 202 and 302 that can result from the operations 400 are now discussed. Referring in particular to FIG. 2, an operator can interact with the user interface 202 so as to validate a reported finding and/or to take action in response to a reported finding. The interface 202 can include an overall or train view 206, which depicts the overall system under inspection. The train view 206 can indicate which part of the train is under inspection. In particular, for example, the train view 206 can indicate that a wagon 208 is under inspection. Additionally, the train view 206 can indicate a number of findings 210 per wagon. In some examples, the train view 206 indicates whether the findings per wagon have been processed or still need to be processed. For example, the number of findings 210 that have been processed can vary in color as compared to the number of findings 210 that still need to be processed, though it will be understood that alternative indications can be included in the train view 206 to differentiate the respective findings. At 212, the position of the operators or maintainers can be shown.

The interface 202 can further include a focused or wagon view 214, which depicts the location under inspection. Continuing with the train example, the focused view 214 can indicate a location of each finding with a finding ID 216. For example, a given finding ID 216a that has been processed can vary in color as compared to a finding ID 216b that still needs to be processed, though it will be understood that alternative indications can be included in the focused view 214 to differentiate the respective finding IDs. In an example, a specific finding ID 216c associated with the finding under investigation can be highlighted or otherwise indicated. Additionally, or alternatively, finding IDs 216d associated with findings that do not have a suggested cause can be highlighted in their own color or otherwise indicated as desired.

Still referring to FIG. 2, the interface 202 can further define a finding list 218 that indicates a list of findings 220. The finding list 218 can include various information associated with each of the findings 220, such as the finding identifier (ID) 216, a location description, and a short description of the respective finding 220. The finding list 218 can further include a confidence level associated with each finding 220. The confidence level can define a consistency measure. The confidence level can indicate how consistent or similar a detected anomaly (finding) is with respect to previously detected anomalies. An anomaly can be classified based on certain expected anomaly details occur. For example, and without limitation, the confidence level can indicate how many of such expected anomaly details exists. By way of further example, and without limitation, a confidence level can be defined by the number of observed and consistent anomaly details minus the number of not observed and expected anomaly details minus the number of contradictory anomaly details. In some cases, each number can be weighted. For example, in some cases, the number of expected and not observed anomaly details can be set to 0 (e.g., they are not counted). The finding list 218 can also include a filter option that an operator can acuate so as view particular findings, such as by filtering findings per wagon. Thus, for each finding 220, the system 200 can display sufficient details such that an operator (e.g., maintainer) can make decisions. For example, based on the displayed details for a given finding, the operators can reject the finding, confirm the finding, or initiate a corrective action related to the finding.

With continuing reference to FIG. 2, the interface 202 can include a context image 222 configured to indicate contextual information related to the finding. The context image 222 can define a photograph or image captured by one of the sensors 106. The context image 222 can further include a name 224 that identifies the object or component rendered in the image, and a marking 226 that identifies the location of the finding associated with the object. In an example, with reference to FIG. 4, the context image 222 can be selected and displayed at 416. The interface 202 can further include a finding image 228 that is associated with the context image 222. The finding image 228 can define an enlarged (zoomed) view of the finding illustrated in the context image 222. The finding image 228 can also include the marking 226. While the marking 226 is illustrated as a dashed boundary line that surrounds the finding, it will be understood that the findings can be alternatively indicated, for instance by arrows, highlights, color, or alternatively shaped boundaries, and all such alternative indications are contemplated as being within the scope of this disclosure.

The interface 202 can further define the control view 230, for instance a point of control view with which the operator can interact to change the perspective of the context image 222. The control view 230 can define an indication, for instance a camera indication 232, that indicates the direction or point of view from which the image 222 was captured. In some examples, the camera indication 232 can be indicated relative to the direction of travel of the train 102, for instance the first direction D1. In an example, the camera indication 232 is rendered on a perimeter 234, for instance a circle though it will be understood that the perimeter 234 can be alternatively shaped, such that the object defining the finding can be viewed from different perspectives along the perimeter 234. For example, the operator can move the camera indication 232 along the perimeter 234, so that the object or finding can be viewed from a human perspective represented by the control view 230. In an example, the system 200 selects the best, for instance highest ranked, image for each point of view, such that the best image associated with a given point of view is displayed when the operator selects the given point of view.

Referring also to FIG. 3, the interface 302 (or finding view 302) can be displayed when an operator selects an option on the interface 202, for instance a camera inspection control option 236. The interface 302 can define a camera inspection viewer 304 that includes a plurality of finding markers 306. In some examples, operators can use the makers 306 to annotate the finding image 204 with additional labels. The viewer 304 can further define an eraser control 308 that allows the operator to remove a given finding marker 306, and a marker control 310 that allows the operator to add one or more finding markers 306 on the image 202. Additionally, or alternatively, the viewer 304 can include a camera control option 312 that can be actuated by the operator or user to capture a new image of the object, for instance by one of the cameras 106.

Referring again to FIG. 2, the interface 202 can also include an action list 238. The action list 238 can define causes related to each finding. The action list 238 can also include corrective actions that are suggested by the system 200, and a confidence level associated with teach cause. In some cases, the action list 238 is generated for each finding, and a given finding can be identified in the action list 238 as a false positive. The action list 238 can also define a new finding option 440, that a user can actuate so as to add a new finding that they recognize on the image.

Referring in particular to FIG. 3, the interface 302 can also include the finding image 204, context image 222, control view 230, and the focused or wagon view 214 described above with reference to FIG. 2. Additionally, or alternatively, the interface 302 can define a control area 314 that renders options to users. For example, users can accept a selected image so that the selected image is displayed in the finding image 204. The control area 314 can also include an option 316 for a user to identify a new finding, and an option 318 for a user to return to the finding view 302. The interface 302 can also include the image gallery or gallery view 320 that indicates the images that have been selected for the respective finding as meeting the image quality criteria described herein. In some examples, the number of available images meeting the quality threshold is displayed (e.g., 24). Thus, in an example, an operator can begin with the interface 202, and can actuate the interface or finding view 302 from the interface 202, for instance if the operator has doubts or wants to explore additional images. The user can return to the interface 202, for instance when the user has selected a preferred image from a preferred point of view.

Thus, as described herein, a plurality of cameras can capture a plurality of images of a system, wherein the plurality of images define different components of the system captured from a plurality of points of view. Based on the plurality of images, a computing system can detect a plurality of findings associated with at least one of the components. The computing system can further determine a first component associated with a first finding of the plurality of findings, and identify a set of images of the plurality of images, wherein each image in the set of images includes the first finding. The system can determine quality metrics associated with each of the images in the set of images, and make a comparison of the quality metric to a quality threshold associated with the first component. Based on the comparison, the computing system can select a subset of images for display to an operator associated with the system. In an example, each image in the subset of images defines the first finding, and the respective quality metric of each image in the subset meets or exceeds the quality threshold.

In some cases, determining the quality metrics includes assigning a value related to each of a plurality of quality parameters, wherein each quality parameter is representative of a feature of the images that can be distinguished by a human eye. In an example, the plurality of quality parameters define an object access parameter that is indicative of a degree to which the first component is covered, such that the first finding is blocked in the respective image from view by the human eye. In various examples, determining the quality metrics further includes determining a weight associated with each of the plurality of quality parameters, wherein the weight is based on the first component (e.g., the identity or location or functionality of the first component). The plurality of quality parameters can be aggregated in accordance with their respective weights, so as to compute the quality metrics. In various examples, the weight is further based on context information associated with the images (e.g., when and where were the images captured). The context information can indicate an environment (e.g., dark or light, time of today, time of year, snow covered, dry, wet, etc.) of the first component when the images are captured. Additionally, or alternatively, the quality threshold (of the overall quality metric and/or specific quality parameters) can be based on context information associated with the images, and the context information can indicate an environment of the first component when the images are captured. Based on the respective overall quality metric associated with each image, the system can rank each image in the subset of images so as to define a first image having the highest quality metric. The system can display the first image having the highest quality metric. Furthermore, the system can identify a point of view associated with each image in the subset of images. The point of view can be defined by a direction from which the first component is viewable in the respective image, so as define multiple point of view classifications. Based on the quality metrics, the system can rank each image in the subset of images with respect to each of the multiple point of view classifications. In an example, the first image is associated with a first point of view classification, such that, responsive to a user actuation, the system can select a second image from a second point of view classification that is different than the first point of view classification. Additionally, the system can display the second image instead of the first image. In particular, based on the quality metrics, the system can determine that the second image has a higher rank as compared to the other images associated with the second point of view classification.

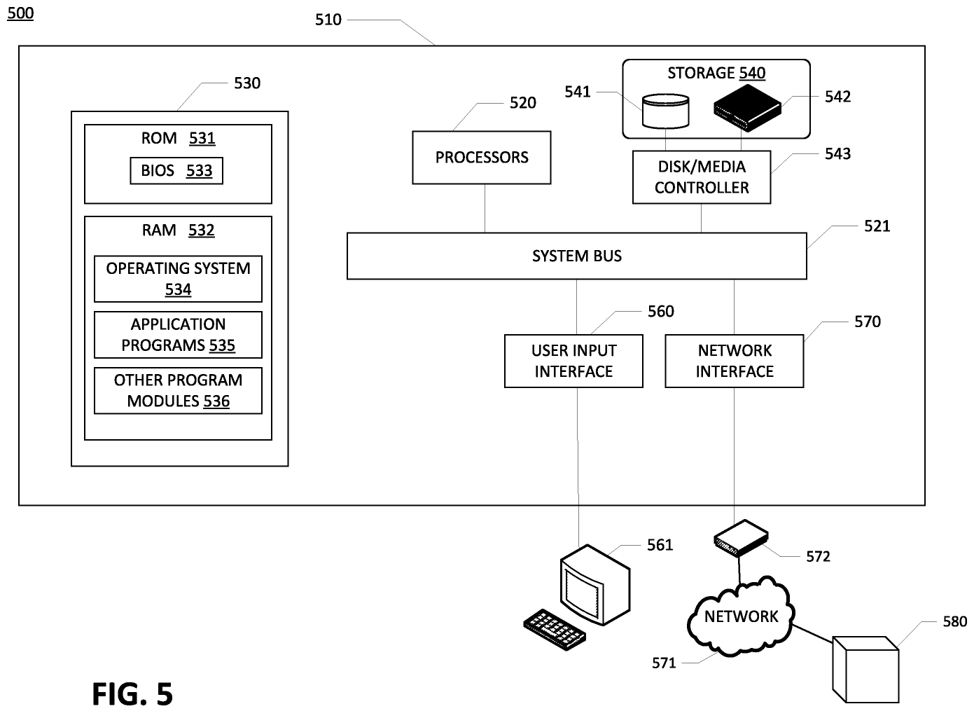

FIG. 5 illustrates an example of a computing environment within which embodiments of the present disclosure may be implemented. A computing environment 500 includes a computer system 510 that may include a communication mechanism such as a system bus 521 or other communication mechanism for communicating information within the computer system 510. The computer system 510 further includes one or more processors 520 coupled with the system bus 521 for processing the information. The operator computer system 200 and/or the central computer system 110 may define the computer system 510. Alternatively, or additionally, the operator computer system 200 and/or the central computer system 110 may include, or be coupled to, the one or more processors 520.

The processors 520 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 520 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 521 may include at least one of a system bus, a memory bus, an address bus, or a message bus, and may permit exchange of information (e.g., data (including computer-executable code), signaling, etc.) between various components of the computer system 510. The system bus 521 may include, without limitation, a memory bus or a memory controller, a peripheral bus, an accelerated graphics port, and so forth. The system bus 821 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 5, the computer system 510 may also include a system memory 530 coupled to the system bus 521 for storing information and instructions to be executed by processors 520. The system memory 530 may include computer readable storage media in the form of volatile and/or nonvolatile memory, such as read only memory (ROM) 531 and/or random access memory (RAM) 532. The RAM 532 may include other dynamic storage device(s) (e.g., dynamic RAM, static RAM, and synchronous DRAM). The ROM 531 may include other static storage device(s) (e.g., programmable ROM, erasable PROM, and electrically erasable PROM). In addition, the system memory 530 may be used for storing temporary variables or other intermediate information during the execution of instructions by the processors 520. A basic input/output system 533 (BIOS) containing the basic routines that help to transfer information between elements within computer system 510, such as during start-up, may be stored in the ROM 531. RAM 532 may contain data and/or program modules that are immediately accessible to and/or presently being operated on by the processors 520. System memory 530 may additionally include, for example, operating system 534, application programs 535, and other program modules 536. Application programs 535 may also include a user portal for development of the application program, allowing input parameters to be entered and modified as necessary.

The operating system 534 may be loaded into the memory 530 and may provide an interface between other application software executing on the computer system 510 and hardware resources of the computer system 510. More specifically, the operating system 534 may include a set of computer-executable instructions for managing hardware resources of the computer system 510 and for providing common services to other application programs (e.g., managing memory allocation among various application programs). In certain example embodiments, the operating system 534 may control execution of one or more of the program modules depicted as being stored in the data storage 540. The operating system 534 may include any operating system now known or which may be developed in the future including, but not limited to, any server operating system, any mainframe operating system, or any other proprietary or non-proprietary operating system.

The computer system 510 may also include a disk/media controller 543 coupled to the system bus 521 to control one or more storage devices for storing information and instructions, such as a magnetic hard disk 541 and/or a removable media drive 542 (e.g., floppy disk drive, compact disc drive, tape drive, flash drive, and/or solid state drive). Storage devices 540 may be added to the computer system 510 using an appropriate device interface (e.g., a small computer system interface (SCSI), integrated device electronics (IDE), Universal Serial Bus (USB), or FireWire). Storage devices 541, 542 may be external to the computer system 510.

The computer system 510 may also include a field device interface 565 coupled to the system bus 521 to control a field device 566, such as a device used in a production line. The computer system 510 may include a user input interface or GUI 561, which may comprise one or more input devices, such as a keyboard, touchscreen, tablet and/or a pointing device, for interacting with a computer user and providing information to the processors 520.

The computer system 510 may perform a portion or all of the processing steps of embodiments of the invention in response to the processors 520 executing one or more sequences of one or more instructions contained in a memory, such as the system memory 530. Such instructions may be read into the system memory 530 from another computer readable medium of storage 540, such as the magnetic hard disk 541 or the removable media drive 542. The magnetic hard disk 541 (or solid state drive) and/or removable media drive 542 may contain one or more data stores and data files used by embodiments of the present disclosure. The data store 540 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 520 may also be employed in a multi-processing arrangement to execute the one or more sequences of instructions contained in system memory 530. In alternative embodiments, hard-wired circuitry may be used in place of or in combination with software instructions. Thus, embodiments are not limited to any specific combination of hardware circuitry and software.

As stated above, the computer system 510 may include at least one computer readable medium or memory for holding instructions programmed according to embodiments of the invention and for containing data structures, tables, records, or other data described herein. The term “computer readable medium” as used herein refers to any medium that participates in providing instructions to the processors 520 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 541 or removable media drive 542. Non-limiting examples of volatile media include dynamic memory, such as system memory 530. Non-limiting examples of transmission media include coaxial cables, copper wire, and fiber optics, including the wires that make up the system bus 521. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 500 may further include the computer system 510 operating in a networked environment using logical connections to one or more remote computers, such as remote computing device 580. The network interface 570 may enable communication, for example, with other remote devices 580 or systems and/or the storage devices 541, 542 via the network 571. Remote computing device 580 may be a personal computer (laptop or desktop), a mobile device, a server, a router, a network PC, a peer device or other common network node, and typically includes many or all of the elements described above relative to computer system 510. When used in a networking environment, computer system 510 may include modem 572 for establishing communications over a network 571, such as the Internet. Modem 572 may be connected to system bus 521 via user network interface 570, or via another appropriate mechanism.

Network 571 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 510 and other computers (e.g., remote computing device 580). The network 571 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 571.

It should be appreciated that the program modules, applications, computer-executable instructions, code, or the like depicted in FIG. 5 as being stored in the system memory 530 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 510, the remote device 580, and/or hosted on other computing device(s) accessible via one or more of the network(s) 571, may be provided to support functionality provided by the program modules, applications, or computer-executable code depicted in FIG. 5 and/or additional or alternate functionality. Further, functionality may be modularized differently such that processing described as being supported collectively by the collection of program modules depicted in FIG. 5 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 5 may be implemented, at least partially, in hardware and/or firmware across any number of devices.

It should further be appreciated that the computer system 510 may include alternate and/or additional hardware, software, or firmware components beyond those described or depicted without departing from the scope of the disclosure. More particularly, it should be appreciated that software, firmware, or hardware components depicted as forming part of the computer system 510 are merely illustrative and that some components may not be present or additional components may be provided in various embodiments. While various illustrative program modules have been depicted and described as software modules stored in system memory 530, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method comprising:
capturing a plurality of images of a system, the plurality of images defining different components of the system captured from a plurality of points of view;
based on the plurality of images, detecting a plurality of findings associated with at least one of the components;
determining a first component associated with a first finding of the plurality of findings;
identifying a set of images of the plurality of images, each image in the set of images including the first finding;
determining quality metrics associated with each of the images in the set of images;
making a comparison of the quality metric to a quality threshold associated with the first component; and
based on the comparison, selecting a subset of images for display to an operator associated with the system,
wherein each image in the subset of images defines the first finding, and the respective quality metric of each image in the subset meets or exceeds the quality threshold.

2. The method as recited in claim 1, wherein determining the quality metrics further comprises:
assigning a value related to each of a plurality of quality parameters, each quality parameter representative of a feature of the images that can be distinguished by a human eye.

3. The method as recited in claim 2, wherein the plurality of quality parameters define an object access parameter, the object access parameter indicative of a degree to which the first component is covered, such that the first finding is blocked in the respective image from view by the human eye.

4. The method as recited in claim 3, wherein determining the quality metrics further comprises:
determining a weight associated with each of the plurality of quality parameters, wherein the weight is based on the first component; and
aggregating the plurality of quality parameters in accordance with their respective weights, so as to compute the quality metrics.

5. The method as recited in claim 4, wherein the weight is further based on context information associated with the images, the context information indicating an environment of the first component when the images are captured.

6. The method s recited in claim 3, wherein the quality threshold is based on context information associated with the images, the context information indicating an environment of the first component when the images are captured.

7. The method as recited in claim 1, the method further comprising:
based on the quality metrics, ranking each image in the subset of images so as to define a first image having the highest quality metric; and
displaying the first image having the highest quality metric.

8. The method as recited in claim 7, the method further comprising:
identifying a point of view associated with each image in the subset of images, the point of view defined by a direction from which the first component is viewable in the respective image, so as define multiple point of view classifications; and
based on the quality metrics, ranking each image in the subset of images with respect to each of the multiple point of view classifications.

9. The method as recited in claim 8, wherein the first image is associated with a first point of view classification, the method comprising:
responsive to a user actuation, selecting a second image from a second point of view classification that is different than the first point of view classification; and
displaying the second image instead of the first image.

10. The method as recited in claim 9, the method further comprising:
based on the quality metrics, determining that the second image has a higher rank as compared to the other images associated with the second point of view classification.

11. A train computing system comprising:
a plurality of cameras configured to capture a plurality of images defining different components of a train, from a plurality of points of view;
a monitor configured to display the images and data associated with the images to an operator;
a processor; and
a memory storing instructions that, when executed by the processor, cause the train computing system to:
based on the plurality of images, detect a plurality of findings associated with at least one of the components;
determine a first component associated with a first finding of the plurality of findings;
identify a set of images of the plurality of images, each image in the set of images including the first finding;
determine quality metrics associated with each of the images in the set of images;
make a comparison of the quality metric to a quality threshold associated with the first component; and
based on the comparison, select a subset of images for display to an operator associated with the system,
wherein each image in the subset of images defines the first finding, and the respective quality metric of each image in the subset meets or exceeds the quality threshold.

12. The computing system as recited in claim 11, the memory further storing instructions that, when executed by the processor, further cause the train computing system to:
assign a value related to each of a plurality of quality parameters, each quality parameter representative of a feature of the images that can be distinguished by a human eye.

13. The computing system as recited in claim 12, wherein the plurality of quality parameters define an object access parameter, the object access parameter indicative of a degree to which the first component is covered, such that the first finding is blocked in the respective image from view by a human eye.

14. The computing system as recited in claim 13, the memory further storing instructions that, when executed by the processor, further cause the train computing system to:
determine a weight associated with each of the plurality of quality parameters, wherein the weight is based on the first component; and
aggregate the plurality of quality parameters in accordance with their respective weights, so as to compute the quality metrics.

15. The computing system as recited in claim 11, the memory further storing instructions that, when executed by the processor, further cause the train computing system to:
based on the quality metrics, rank each image in the subset of images so as to define a first image having the highest quality metric; and
the monitor is further configured to display the first image having the highest quality metric.

16. The computing system as recited in claim 15, the memory further storing instructions that, when executed by the processor, further cause the train computing system to:
identify a point of view associated with each image in the subset of images, the point of view defined by a direction from which the first component is viewable in the respective image, so as define multiple point of view classifications; and
based on the quality metrics, rank each image in the subset of images with respect each of the multiple point of view classifications.

17. The computing system as recited in claim 16, the memory further storing instructions that, when executed by the processor, further cause the train computing system to:
receive a user actuation; and
responsive to the user actuation, select a second image from a second point of view classification that is different than the first point of view classification,
wherein the monitor is further configured to, responsive to the user actuation, display the second image instead of the first image.
